(19) United States
(12) Patent Application Publication
(10) Pub. No.: US 2024/0289648 A1
(43) Pub. Date: Aug. 29, 2024

(54) METHOD AND DEVICE FOR PERFORMING PREDICTIVE ANALYSIS OF THE BEHAVIOUR OF AN OPERATOR INTERACTING WITH A COMPLEX SYSTEM

(71) Applicant: THALES, MEUDON (FR)

(72) Inventor: Jean-Yves DONNART, MERIGNAC (FR)

(21) Appl. No.: 18/572,722

(22) PCT Filed: Jun. 22, 2022
(86) PCT No.: PCT/EP2022/066975

§ 371 Date: Jan. 17, 2024

(30) Foreign Application Priority Data
Jun. 24, 2021 (FR) 2106748

(51) Int. Cl. G06N 5/022

(52) U.S. Cl. CPC G06N 5/022

(57) ABSTRACT

A device and a method implemented by computer, allowing the behavior and the actions of an operator interacting with a complex system to be predicted, based on the observation of his/her behavior in real time and on the instantiation of models of human behavior which are constructed by learning from past data collected for a plurality of operators, the models of human behavior having been learnt by the application of artificial intelligence techniques to cognitive models and to procedural models taking into account parameters of human factors of influence.

### CROSS-REFERENCE TO RELATED APPLICATIONS

This application is a National Stage of International patent application PCT/EP2022/066975, filed on Jun. 22, 2022, which claims priority to foreign French patent application No. FR 2106748, filed on Jun. 24, 2021, the disclosures of which are incorporated by reference in their entireties.

### FIELD OF THE INVENTION

The invention relates to the general field of systems assisting the monitoring of the states of individuals, and in particular it provides a method and a device allowing the behavior of an operator interacting with a complex system to be predicted, based on the observation of his/her behavior in real time and on behavior analysis models constructed on past data, collected for a plurality of operators situated on complex systems.

### BACKGROUND

The invention thus covers several fields which are the analysis of the human behavior of persons interacting with a complex machine (for example an aircraft pilot or driver of a terrestrial or maritime or railroad vehicle, or else an air traffic controller or a power station (nuclear or otherwise) operator or a production line controller) and the modeling of the behavior of a stand-alone player (constructive player in a simulation or non-playing character in a video game).

The analysis of human behavior, often also referred to as “human factors analysis”, allows the actions of a person to be analyzed using cognitive models so as to enable their actions to be explained.

The modeling of the behavior allows players in a constructive simulation or non-playing characters in a video game to be animated, by endowing them with programmable behaviors.

The technical field addressed by the invention is on the border between the two fields of the analysis of human behavior and of the modeling of the behavior, which is defined as the “modeling of human behavior” and which endeavors to reproduce the behavior of real people.

The aim of the invention is to use this capacity for modeling human behavior in order to improve the analysis of the behavior of an operator as far as being able to predict his/her future behavior as a function of the current situation such as perceived by this operator, and as a function of the evaluation that is made of his/her cognitive state.

The field of application of the invention is thus that of the “prediction of the behavior of an operator interacting with a complex system”.

The technical problem addressed by the present invention is that of how to produce a device (and an associated method) which allows the behavior of an operator interacting with a complex system (for example a pilot in his/her aircraft) to be anticipated and to be predicted based on the observation of his/her behavior in real time and on analysis models established using the analysis of past data which have been collected for a set of operators on a system of the same nature. For example, the invention allows the behavior of a pilot to be predicted using models created based on data gathered during real or simulated flights.

Indeed, even when an operator has to follow, in theory, regulated procedures, it is observed that it is very difficult to predict his/her behavior in every circumstance. When confronted with a scenario identical in every aspect, each individual, rather than following a procedure to the letter which is nonetheless common to all the operators of the same type of complex system, will adopt a different behavior depending on his/her experience, on his/her cognitive state and, more generally, depending on the way in which he/she evaluates the current situation.

At the present time, there exists no known device allowing the complete behavior of an operator interacting with a complex system to be anticipated. On the other hand, for example in the field of aeronautics, there do exist:
devices which allow the performance capacities of a pilot to be evaluated with respect to the regulated flight procedures or with respect to a reference learnt from the observation of experienced pilots;
devices which allow flight paths of one or of several aircraft to be predicted based on physical models of each aircraft involved;
devices which allow certain characteristics of pilots to be determined based on their observed behavior, so as to deduce from this a capacity for taking risks for example.

The same goes for the other devices involving an operator confronted with a complex system. The existing devices which come closest to the invention described here allow models to be constructed based on a set of data on behaviors of an operator, in order to evaluate certain aspects of his/her cognitive state (management of the mental load, evaluation of the situation, etc.). This evaluation of the state of the operator is used notably to assist an instructor during training sessions in a simulator of the complex system.

The scope of the existing solutions remains more limited than that of the present invention.

Furthermore, the known approaches do not allow the behavior of an operator interacting with a complex system to be predicted, including, for example, a person acting in an environment as restrictive as that of a pilot in his/her cockpit, because the models used are not sufficiently developed, and exhibit respective shortcomings. These are as follows:
the cognitive models used for the analysis of the behavior do not take into account the contextual data (for example the mission of a pilot underway). This shortcoming means that these models alone do not allow the trend over time of the cognitive state of the operator to be understood and hence to be predicted; and
the models of behavior used in constructive simulations or video games are lacking a sufficiently realistic representation of the cognitive state of the simulated players. This shortcoming does not allow the generation of a more human behavior and hence closer to the observed behavior of the operator, and does not allow this behavior to be recognized and its trend over time to be anticipated.

The patent application US 2019/158484 A1 by Grunewald et al. provides a solution for predicting the behavior of an operator in terms of actions to be performed but in the very limited framework of a game whose situations are by necessity limited by their designer. This is not therefore a complex system (such as a real vehicle or a nuclear power station) where the number of situations is not limited and could be represented by a graph of discrete states. Furthermore, this system, which is aimed at constructing a network of affinities between players, does not take into account the trend over time of the cognitive state in the training of the player models, but solely biometric characteristics preset for each player.

The patent application US 2021/107501 A1 by Monteil et al. provides a solution for predicting behavior of a complex system (an automobile), together with a prediction of the cognitive state of an operator (in this case, the state of health of the driver), which uses a model of correlation between the behavior of this system and the state of this operator in order to evaluate risks of an accident. However, this solution is not aimed at predicting the behavior of the driver as such but rather the behavior of the car that he/she is driving (the velocity, the acceleration, etc.) and of its immediate environment (the distance from other vehicles for example). Although the trend over time of the behavior of the complex system may clearly result from the control commands of the operator, it is above all the result of the dynamics of the vehicle and it is principally this which is recorded in the models provided. The only parameters associated with the operator which are used in these models relate to the state of health of the driver whose correlation can enable accident-causing situations to be detected.

Accordingly, no known solution provides a device and a method allowing the complete behavior, i.e. from both the cognitive and the operational standpoint, of an operator interacting with a complex system to be anticipated.

There exists the need for a solution which is concentrated on the behavior of the operator, on his/her decision-making processes, on his/her interactions with the complex system on which he/she is operating, on the multiple influences that his/her current cognitive state may have on his/her behavior, his/her decisions and his/her interactions.

### SUMMARY OF THE INVENTION

One object of the invention is to meet the aforementioned needs and to overcome the drawbacks of the existing solutions and techniques.

The general principle of the invention consists in implementing, in a device for predicting the behavior of an operator, an analysis engine referred to as “engine for predicting the behavior of the operator” which instantiates, for the operator being observed, a model of human behavior for this operator.

In order to predict the behavior of the operator, and not just that of the complex system with which he/she is interacting, the solution provided relies on the use of additional data with respect to those used in the solutions of the prior art. In addition to data describing the dynamics of the complex system and of the immediate environment, and to physiological data of the operator, data on interactions between this operator and his/her machine for identifying what he/she is doing (manipulation data), what he/she is looking at (observation data) and what he/she is saying or hearing (communications data) are collected and used for constructing a new model of human behavior based on procedural models and on cognitive state models which are of different natures from those of the models of the prior art.

Indeed, the learnt procedural models record the correlations between these data on interaction between the operator and his/her machine with expert data corresponding to the rules, to the sequences of actions or to the procedures for use of the complex system (for example flight procedures). The data corresponding to the dynamics of the vehicle are only used in a contextual manner in order to determine when the procedural models must be used for comparing them with the behavior of the operator.

In the same way, the cognitive state models rely on a medical expertise for categorizing complex states such as the stress, the capacity to manage a workload or the awareness of the situation. These models are learnt from physiological data recorded on the operator but also using data on interaction between the operator and the machine and contextual data.

The aim of these models is not the evaluation of the health of the operator which could cause an accident but a more targeted evaluation of the cognitive state of the operator able to explain the differences between the observed behavior and the procedures that the operator is supposed to implement.

This influence of the cognitive state on the behavior of the operator may be of three types: it may have a bearing on the choice of the procedure to be applied by the operator; it may modify the effectiveness of the actions of manipulation, of observation or of communication that the latter performs; and it may generate behaviors outside of any procedure which are directly produced by the mental state of the operator (a movement of panic for example).

Thus, the device provided and the model of human behavior rely on a Knowledge Base of Operator Behavior (BCCO), which has been constituted upstream of an execution of the method and which contains a set of data recorded during interactions of operators with complex systems, for existing procedural regulations (depending on the field of application).

The prediction engine of the device of the invention is based on a predictive model which combines both the procedural aspects of the work of the operator and cognitive aspects of the operator, such as his/her fatigue, his/her stress or his/her mental load.

The device of the invention processes, on the one hand, the analysis of the state and the behavior of the operator and, on the other, it allows the anticipation in the short term of this state and behavior with the aid of the predictive model which will generate data that will allow the behavior of the operator to be anticipated, including for situations to which he/she has not been exposed.

Several Artificial Intelligence (AI) devices, mixing both automatic learning algorithms and formal methods exploiting a professional expertise, allow what is referred to as a “model of human behavior of the operator” to be constructed in an iterative manner, in other words a model capable not only of reproducing the procedural behavior of the operator but also of taking into account the human factors which may come into his/her decision-making process (cognitive aspect).

This model of human behavior is instantiated in the engine for predicting behavior in order to anticipate, in real time, the future actions of the operator, with a coefficient of probabilities of occurrence on the possible action or actions.

The major advantage of this device with respect to the existing ones is that the prediction model takes into account both categories of factors which have an influence on the human decision, namely the procedural aspects (i.e. follow a plan, comply with the rules, etc.) and the cognitive aspects (i.e. the stress, the capacity to manage several tasks, etc.).

The present invention will be applicable to many fields of application where the need exists to anticipate the actions and the behaviors of an operator of a complex system.

The fields of application of the invention are the fields of activity in which a complex system is controlled and implemented by one or more operators. These professional fields comprise for example industry and aeronautical, rail and road transport, the fields of safety and security, the fields of the control of processes, etc.

One of the main fields sensitive to the issue of the prediction of the behavior of an operator, whether this be for questions of safety or of performance (i.e. reduction in the number of operators for a given task), is the field of aeronautics with the “Crew Monitoring System” concept able to allow “Single Pilot Operation” (SPO) or “Single Pilot in Command” (SPIC) applications, according to the terminology of the art.

Thus, the device of the invention, in the aeronautical context, participates in several fields of innovation which are: the development of the cockpit of the future, the monitoring of pilots (in flight or otherwise), the physiological and psycho-physical monitoring of the latter, the safety of flights, the performance of the mission or else the training of pilots.

The device provided aims to solve, for both the aeronautical field and more generally for other fields, the problem of how to guarantee the performance of an operator from a cognitive and operational standpoint. This problem involves multiple issues and raises several technical questions, because it is indeed necessary to be capable of measuring several physiological parameters in a manner that is as non-invasive as possible, of interpreting these signals, of compiling them with contextual data relating to a mission, of producing relevant prediction information on the behavior of the operator, in order to decide whether the performance of the operator requires adaptations to be applied to the plan of the mission, either on the complex system, on the environment of the mission, or else with regard to the operator.

In order to obtain the results sought, a predictive method of analysis is provided of the behavior of an operator interacting with a complex system during a real or simulated mission, the method being implemented by computer and comprising steps of:
collecting data characterizing actions of observation, of manipulation and of communication of the operator, physiological data relating to the operator and contextual data encompassing data on the state and the dynamics of the complex system, environmental data and data relating to the context of the mission and, potentially, subjective data on the behavior of the operator;
using the data collected as inputs of an engine for predicting behavior so as to generate prediction data representing actions and behaviors that said operator could carry out in the short term; and
analyzing the prediction data in order to determine whether technical adaptations are to be applied to the interaction between the operator and the complex system; the method being characterized in that the step for generating prediction data consists in implementing, via said engine for predicting behavior with the data collected, a model of human behavior configured for modeling the behavior of said operator with regard to the cognitive and procedural aspects, said model of human behavior instantiated for said operator having been learnt in a learning phase by the application of artificial intelligence techniques on cognitive models and on procedural models, using, over many simulations, a plurality of teaching data of the same nature as said collected data, but for various operators, the teaching data being capitalized in a knowledge base of the behavior of operators of complex systems.

In one embodiment, the step for implementing the model of human behavior for said operator comprises steps of:
determining from a sub-set of the collected data one or more cognitive states of the operator;
characterizing from a sub-set of the collected data the perception of the situation by said operator, for the operational phase during the mission;
using the data on cognitive states as parameters of human factors of influence for the determination of behaviors and of actions of the operator, depending on the perception of the situation;
   the model of human behavior being represented as a hierarchical graph comprising modules of cognitive behaviors and modules of tasks relating to a mission, the modules of cognitive behaviors and the modules of tasks being decomposed into modules of behaviors, the modules of behavior being decomposed into modules of actions, the actions being elementary actions observable on the operator, the graph comprising an output level corresponding to a selection of elementary actions.

In one embodiment, the parameters of human factors of influence on the determination of behaviors and of actions of the operator are used at several levels of the hierarchical graph.

In one embodiment, the parameters of human factors of influence are used at a first level of the graph for determining cognitive behaviors, at a second level of the graph for determining behaviors and actions, and at a third level of the graph for determining a selection of actions.

In one embodiment, the step for analyzing the prediction data to determine whether technical adaptations are to be applied to the interaction between the operator and the complex system consists in identifying possible risks for the mission, linked to predicted actions and behaviors of the operator.

In one embodiment, the method further comprises a step consisting in determining adaptation suggestions with regard to the interaction between said observed operator and the complex system.

In one embodiment, the method further comprises steps of:
generating written and/or visual and/or audible warnings intended for said observed operator and/or for co-operators and/or for control services; and/or
generating written and/or visual and/or audible assistance suggestions for said observed operator and/or for third-parties; and/or
adapting/reconfiguring HMIs used by said observed operator in order to facilitate his/her actions; and/or
adapting/modifying an operation within the complex system in order for a predicted action not to be realized or for it to be carried out differently.

In one embodiment, the method further comprises a step consisting in supplying the collected data to the input of the model of human behavior as teaching data.

In one embodiment, the method comprises initial steps consisting of an automatic learning of models of human behavior.

In one embodiment, the step for automatic learning of the models of human behavior comprises steps of:
constructing a knowledge base of operator behavior BCCO using data coming from operators interacting with the complex system;
using the data from the BCCO for constructing by learning a database of cognitive models;
using the data from the BCCO for constructing by learning a database of models specific to each operator or to each category of operators;
using the data from the BCCO, the data from the database of cognitive models, the data from the database of specific models, for constructing by learning:
   cognitive state models allowing the trend over time of the human factors parameters to be modeled as a function of the context represented by the operator and the task that he/she is performing using the complex system;
   mission models integrating into their rules of operation parameters of human factors of influence coming from the cognitive state models, the parameters being taken into account according to three levels of influence;
      the combination of cognitive state models and of mission models constituting models of human behavior for operators or for categories of operators.

The invention also covers a computer program product comprising code instructions allowing the steps of the claimed method to be carried out when the program is executed on a computer.

The invention additionally covers a device for predictive analysis of the behavior of an operator interacting with a complex system during a real or simulated mission, the device comprising:
a plurality of sensors configured for collecting data corresponding to the actions of observation, of manipulation and of communication of the observed operator, physiological data relating to this operator and various contextual data relating to the state and the dynamics of the complex system, relating to the environment and to the context of the mission;
a data processing module coupled to the various sensors, and comprising code instructions allowing steps to be carried out consisting in:
   using the data collected as inputs of an engine for predicting behavior in order to generate prediction data representing actions and behaviors that said operator could carry out in the short term; and
   analyzing the prediction data to determine whether technical adaptations are to be applied to the interaction between the operator and the complex system;
      the device being characterized in that the engine for predicting behavior implements, with the collected data, a model of human behavior configured for modeling the behavior of said observed operator with regard to the cognitive and procedural aspects, said model of human behavior instantiated for said observed operator having been learnt, in a learning phase, by the application of artificial intelligence techniques to cognitive models and to procedural models, using, over many simulations, a plurality of teaching data of the same nature as said collected data, but for various operators, the teaching data being capitalized in a knowledge base of the behavior of operators of complex systems.

The device of the invention further comprises other means for implementing the steps of the method of the invention.

One use of the claimed device is that of the predictive analysis of the behavior of a pilot interacting with an aircraft platform during a real or simulated mission.

The invention also covers a method for constructing models of human behavior. The model of human behavior allows the behavior of an operator to be modeled both in the cognitive aspect and in the procedural aspect.

The method for obtaining the model of human behavior relies on a “Knowledge Base of Operator Behavior” (BCCO) and on two separate models-a cognitive model and a procedural model.

The BCCO allows a set of data collected during interaction sessions of operators with complex systems (data characterizing the actions of observation, of manipulation and of communication of the operator, physiological data relating to this operator and contextual data describing the state and the dynamics of the complex system, the environment and the context of the mission, to which subjective data on the behavior of the operator are added) to be recorded and to be capitalized.

One method allows various categories of cognitive models to be constructed, based on data recorded in the BCCO, using artificial intelligence techniques for the automatic learning, such as for example a mental load model. Those skilled in the art will apply the same principles for constructing any other cognitive model corresponding to other aspects of the cognitive state of the operators interacting with a given complex system.

Another method allows, based on data recorded in the BCCO and using artificial intelligence techniques for the automatic learning, models of behavior for constructive simulation, referred to as “Constructive Models”, to be constructed, which are also denoted as “procedural models”.

The data from the BCCO, the data from the database of cognitive models, the data from the database of procedural models, are subsequently used for constructing by learning:
cognitive state models allowing the trend over time of parameters of human factors of influence to be modeled, as a function of the context represented by the operator and the task that he/she is performing in his/her interaction with the complex system;
mission models integrating into their rules of operation, based on the procedural models, the parameters of human factors of influence coming from the cognitive state models, the human factors being taken into account according to three levels of influence;
the combination of cognitive state models and of mission models constituting models of human behavior for operators or for categories of operators.

### BRIEF DESCRIPTION OF THE DRAWINGS

Other features, details and advantages of the invention will become apparent upon reading the description presented with reference to the appended drawings given by way of example, and which respectively show:

FIG. 1 illustrates schematically, for the example of a pilot, the phase for modeling cognitive models and the phase for executing the models in order to evaluate the cognitive state of a pilot;

FIG. 2 illustrates schematically how the phase for modeling procedural models and the phase for executing the models is used to generate the behavior of a virtual pilot in a constructive simulation;

FIG. 3 illustrates the steps for constructing a model of human behavior according to the invention, in the example of a pilot;

FIG. 4 illustrates schematically one environment allowing the prediction method of the invention to be implemented;

FIG. 5 illustrates a sequence of steps of the method of the invention for the predictive analysis of the behavior of an operator interacting with a complex system during a real or simulated mission;

FIG. 6 illustrates one example of implementation of the underlying structure of the model of human behavior of the invention; and

FIG. 7 illustrates one example of prediction of the actions of an aircraft pilot, based on the hierarchical structure in FIG. 6.

### DETAILED DESCRIPTION

Although the invention is described for one preferred embodiment in the field of avionics, for analyzing the state and the behavior of a pilot and for predicting his/her behavior, those skilled in the art will be able to transpose the principles described to other fields.

Furthermore, in the description, the following definitions are assigned to the terms listed hereinafter:
Operator: individual, subject, person, human interacting with (i.e. piloting, controlling, activating, operating, acting on) a complex system. For the embodiment described, the operator is a pilot, and one or the other term may be used without distinction.
Complex system: system comprising numerous devices with which an operator has to interact, and which may involve on his/her part a longer or shorter time for his/her manipulation together with a more or less significant implication for his/her mental load. The complex system is an aircraft cockpit for the embodiment described.

Before describing the invention, the following points are recalled which are needed for its complete understanding.

### Reminder on Human Factors Analysis:

Human factors analysis, and in particular the analysis of the behavior of an operator of a complex system, is based on the development and the use of cognitive models whose purpose is to evaluate, for each of these models, one aspect of the cognitive state of the person being observed. One of these cognitive models is that which allows the mental load, for example of a pilot on an exercise or on a mission, to be evaluated.

The constitution of a “Knowledge Base of Pilot Behavior” (BCCP) accumulating, over many operational or simulated flight sessions, data recorded on the behavior of civilian aircraft pilots should allow new cognitive models to be constructed that are capable of evaluating other aspects of the state of the pilot (alertness, drowsiness, incapacity, etc.). Other cognitive models may be implemented for other fields of application (air traffic controller, operator of a nuclear power station, etc.).

### Reminder on the Modeling of the Behavior:

Models of behavior are used by constructive simulations and by video games in order to animate the behavior of the actors not played by the trainee, the player or, more generally, the operator of this type of application. These models allow the behavior of artificial actors to be generated who will carry out tasks or missions in the framework of a predefined scenario.

In almost all of the constructive simulations or games, the models of behavior are procedural, in other words the generated behavior corresponds to a series of pre-recorded actions, generally organized in the form of a graph or by a set of “Conditions→Actions” rules, being activated according to the perceptions of the actor in his/her environment.

The procedural models of behavior are generally developed manually by an expert in the field (a “game-designer” for games) in a procedural form (graph, tree structure, etc.) in order to model the various possible sequences of events in the course of a mission.

These procedural models are generally constructed upstream by the modeler in order to be used during the execution of the simulation or of the game but, owing to their simplicity, they may also be constructed or modified during the running of this simulation or of this game.

### Reminder on the Modeling of Human Behavior:

The concept of modeling of human behavior (MCH) appeared in the field of simulation in the 90s with the idea that a modeling of the human factors would need to be included in order to parameterize the manner in which automatons must make their choices of behavior, and thus avoid having to face a virtual enemy with robotic behavior, that is easily predictable and is often able to be deceived.

In contrast to the behavior that may be generated by procedural automatons, human behavior is characterized by the involvement of the cognitive state in the decision-making process. This being said, the behavior of a human being is not only much richer than that of any given automaton, but it is also much less predictable since an external observer does not generally have access to the cognitive state of the person being observed, unless they are able to deduce a part of this hidden state by the expression on his/her face, by his/her posture or by any other indicator of his/her physiological state.

There are numerous studies in the academic field on the characterization of various aspects of the cognitive state of a human being, such as for example:
the studies on human behavior recognition (HBR) which rely on psychological or psycho-physiological models (such as for example the models of alertness or of mental load);
numerous academic Artificial Intelligence systems are also inspired by psychological models, for example the BDI (“Believe, Desire, Intent”) model of Michael Bratman, by psycho-physiological models, for example the model of Nico Frijda on emotions, or by biomimetic models, for example the models of David McFarland and of Toby Tyrrell on motivations.

In the field of constructive simulation, it has been demonstrated that human factors (FH) could be used, which correspond to the various psychological and physiological parameters characterizing a real person, in order to influence the decision-making of the artificial actors.

Thus, the human factors may intervene at three levels in the decision-making process:
a first level (FH1) where the human factors may trigger a new behavior, for example in order to satisfy a motivation or to respond to a certain emotion;
a second level (FH2) where the human factors may influence the choice between several ways of implementing a given behavior;
a third level (FH3) where the human factors may have an influence on the efficiency with which selected actions will be implemented.

Coming back to the present invention, it includes a modeling method which allows a database of models of human behaviors for the operators to be constructed and it relates to a device for predicting behavior which relies on this database for predicting the behavior of an operator.

The models of human behavior of the operators are constructed according to a method which combines cognitive models and procedural models of behavior. Each model of human behavior corresponds to a given operator and/or to a class of operators, for a given complex system.

The method for constructing this new model of human behavior implements:
a format of model of behavior which combines the two categories of models involved (cognitive and procedural);
a professional expertise for identifying at which levels of the tree structure of the procedural model links with the “human factors” (FH) generated by the cognitive models (following the three levels of influence of the FH described above) may be integrated;
a progressive improvement of the models of human behavior of the operator by automatic learning techniques using the data from the knowledge base of operator behavior (BCCO) as reference.

The engine for predicting the behavior allows the next/future actions of an operator (in the short term) to be predicted, using the model of human behavior that best corresponds to this operator, according to the analysis of the state and of the procedural behavior of the operator which is effected based on all of the collected data, for the complex system with which he/she is interacting and depending on the task that he/she has to perform (with respect to the mission underway).

The data input into the prediction engine correspond to a set of data recorded at the time of the prediction request: data on the actions of observation, of manipulation and of communication of the operator, physiological data recorded on this operator and contextual data relating to the state and to the dynamics of the complex system, to the environment or to the mission of the operator for example.

The data output from the prediction engine correspond to predicted actions, associated with the elements of behavior which have been identified and selected for the prediction analysis.

When several actions are provided, these are associated with a coefficient of probability.

The advantages of the device of the invention and of the associated method are to combine, within the model used for making the prediction, both objective data corresponding to the procedures implemented by the operator and data corresponding to an evaluation of the state of this operator. This being said, it is possible to identify, in the use case data recorded in the BCCO, the context in which each decision of the operator is taken and to reuse this information so as to be able to anticipate, during a new experience, the behavior of an identical operator or one considered to be similar in his/her behavior.

The various phases allowing the models needed for the operation of an engine for predicting the behavior of an operator interacting with a complex system according to the invention to be created are now described. They comprise:
(A) A phase for constituting a “Knowledge Base of Operator Behavior”;
(B) A phase for constructing cognitive models;
(C) A phase for constructing procedural models; and
(D) A phase for constructing models of human behavior.

### (A) Constitution of a Knowledge Base of Operator Behavior (BCCO)

The constitution of a Knowledge Base of Operator Behavior (BCCO) makes available the behavior use cases and the corresponding data needed to construct the models used to predict the behavior of an operator interacting with a given complex system.

The BCCO may be implemented, at a first stage, using data coming from experimentations on instrumented simulators of the complex system, which facilitates both their collection and allows them to be saved subsequently. For example, cognitive models of pilots have been constructed from data collected on civilian aircraft simulators.

It is possible to carry out a data collection directly on real systems (for example on a civilian aircraft during a flight).

The Knowledge Base of Operator Behavior is enhanced and completed over time so as to be able to refine the models and, in particular, those used for the prediction.

The BCCO is composed of data of various natures synchronously recorded, by suitable sensors, such as:
data relating to the actions of the operator:
   actions of observation (what the operator is looking at);
   actions of manipulation (what the operator is doing using the instruments of the system);
   actions of communication (what the operator is transmitting by voice using the system);
physiological data (recorded on the operator using biometric sensors);
contextual data (state and dynamics of the system, environment of the system, mission or current task of the operator, actions noticed by other actors, self-evaluation of the operator or evaluation of an external person, etc.).

In the case of the prediction of the behavior of a pilot, in addition to the devices specific to the cockpit, the cockpit of the aircraft and the pilot are instrumented with an assembly of sensors allowing all the preceding types of data to be recorded, so as to constitute a knowledge base of pilot behavior (BCCP).

In one embodiment, a processing of inter/intra personnel and inter/intra operational variability may be applied to the data in order to group them and to allow the construction of more generic models (in other words not linked to a single operator). For example, in the case of pilots:
it is possible to group data from pilots who are judged sufficiently similar in terms of training, of service time, of routes, etc. in order to construct models for classes of pilots;
it is possible to group data from different pilots but flying on the same class of aircraft and over similar routes in order to construct models for classes of missions.

Those skilled in the art thus understand that the quality of the prediction depends on the quality of the database of the models of human behavior for the operators which, itself, depends on the quantity of data which could have been collected in the BCCO.

### (B) Construction of Cognitive Models

The “Models of Cognitive Behavior”, or “Cognitive models”, are used for the human factors analysis.

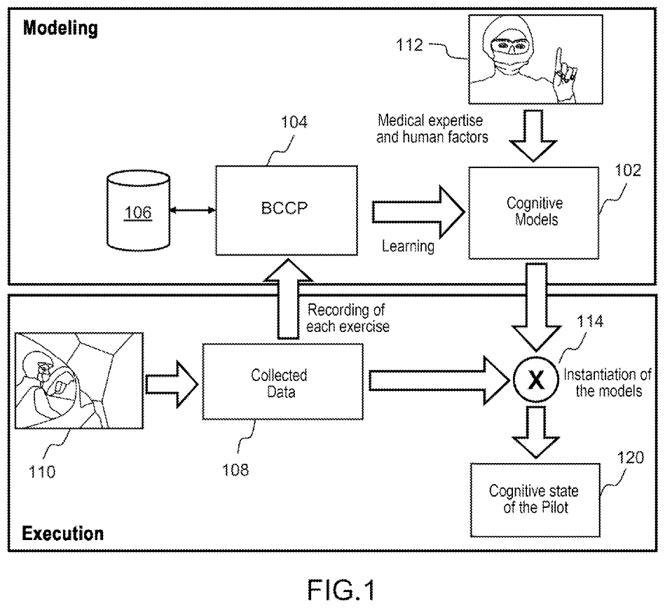

FIG. 1 illustrates schematically, for the example of a pilot, how the cognitive models (102) are generated (Modeling Phase) and how these models are used (Execution Phase) for evaluating (120) the cognitive state of a pilot, using the data from a “Knowledge Base of Pilot Behavior” (BCCP) (104) grouping data (106) recorded, over many operational or simulated flight sessions, on the behavior of the pilot: actions of the pilot (actions of observation of the exterior of the cockpit and of the instruments, actions of manipulation on the controls and the instruments of the aircraft, actions of communication); physiological parameters recorded by biometric sensors; contextual information on the state and the dynamics of the complex system (the aircraft), on the environment (weather, other actors/tactics/traffic, etc.), on the mission of the pilot (flight plan and phases for example) or on more subjective information on his/her behavior (observation, declaration, annotation, qualification, etc.).

The cognitive models are established by artificial intelligence techniques for the learning, using data (108) collected during several exercises where the complex system and the operator are instrumented (110), for example in an aircraft simulator instrumented for this purpose. Exercises corresponding to realistic and productive scenarios with operational and cognitive variations are carried out. The collected data, which group objective data (sensor measurements; probe of the simulator; scenario) and subjective data (self-appreciation; external expertise), are synchronized and supplied to the Knowledge Base of Pilot Behavior or, more generally, of Operator Behavior (104).

It should be noted that the learning is never done blind and, more often than not, it involves experts (112) for defining the type of model that it is desired to construct by choosing, for example, the parameters to be used.

The prior constitution of a Knowledge Base of Pilot Behavior (BCCP) or, more generally, of a Knowledge Base of Operator Behavior (BCCO) containing synchronized recordings of interaction sessions with the complex system used is thus a prerequisite for constructing cognitive models, whether this be for evaluating the mental load of an operator or other aspects of the state of an operator, i.e. his/her alertness, his/her drowsiness, his/her incapacity, etc.

As illustrated in FIG. 1, in the execution phase, the collected data are inputs of an execution engine (114) which instantiates the appropriate cognitive model (102) in order to deliver information (120) representative of the cognitive state of the pilot/operator.

### (C) Construction of Procedural Models

“Constructive models of behavior” or “procedural models” are used by the constructive simulations to generate the behavior of each actor not played by the trainee or by the instructor, and to allow this actor to carry out its mission as a function of the situation that it perceives.

The procedural models are generally developed manually by an expert in a procedural form (with a graphical representation, tree structure, etc.) for modeling the various possible sequences of events in the course of a mission. These procedural models may be constructed live by the trainee or the instructor during the exercise, or they may be constructed by a modeler and recorded in a database in order to be re-used in the course of the exercise.

Techniques exist allowing procedural models to be constructed which are in part the result of an automatic learning and where the expert intervenes upstream in order to, for example:
Structure the organization of the behaviors (for example: a genetic learning from collective missions);
Simplify the data at the input (for example: a learning from behavioral trees);
Define the experiences to be recorded (for example: a learning by case).

The use of the learning is especially useful when it is difficult, or would take too long, to construct a procedural model of behavior which covers all the situations encountered. As soon as the problem becomes too complex in number of possible situations, it becomes necessary to construct a more generic model using an automatic learning.

On the other hand, as in the case of the learning for cognitive models, the processing time for a complete procedural model of behavior quickly becomes prohibitive without the aid of an expert on the system under study for identifying the parameters to be optimized or for defining in advance the structure of the model.

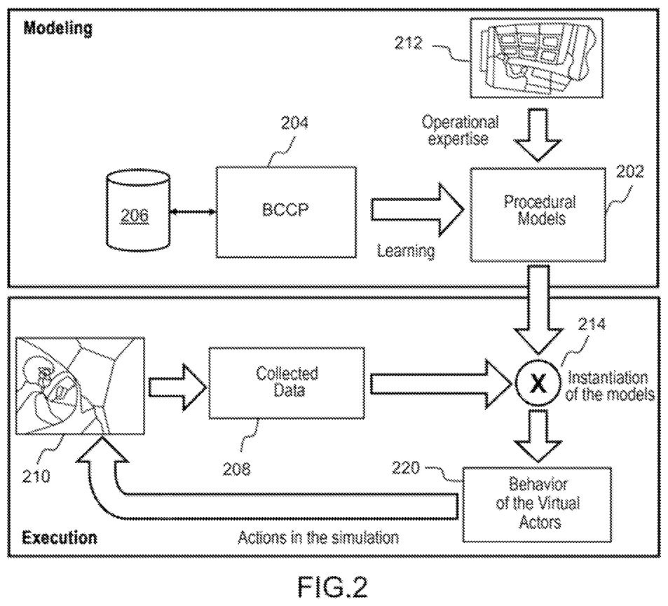

FIG. 2 illustrates schematically how the procedural models (202) are established (Modeling Phase) and how these models are used (Execution Phase) to generate (220) the behavior of the virtual pilot in a constructive simulation.

The modeling phase allows procedural models to be constructed using as reference for learning a more general behavior than that provided by operational experts (212), the data recorded in a “Knowledge Base of Pilot Behavior” (BCCP) (204) grouping, over many operational or simulated flight sessions, data (206) recorded on the behavior of the pilot: actions of the pilot (actions of observation of the exterior of the cockpit and of the instruments, actions of manipulation on the controls and the instruments of the aircraft, actions of communication); physiological parameters recorded by biometric sensors; contextual information on the state and the dynamics of the complex system (the aircraft), on the environment (weather, other actors/tactics/traffic, etc.), on the mission of the pilot (flight plan and phases for example) or on more subjective information on his/her behavior (observation, declaration, annotation, qualification, etc.).

In the execution phase, the procedural models (202) are instantiated in the behavior engine of a constructive simulation (214) with the data from a simulation (208, 210) in order to generate (220) information representative of the behavior of the artificial pilot.

### (D) Construction of Models of Human Behavior

The models of human behavior established by the inventors are models enhancing the procedural models with additional parameters which come from the evaluation of the cognitive state of the operator.

Advantageously, the models of the two categories of known models (procedural; cognitive) are combined into one single modeling structure.

The learning of the new models of human behavior is based on each of these two categories by integrating both procedural components and cognitive components of the decision-making process.

As has been previously developed, it is possible to construct a procedural model that is sufficiently sophisticated so as to be able to predict the behavior of an operator interacting with a complex system, as long as this operator rigorously follows the procedures of use of this system and the prediction device disposes of the same inputs as the operator for making its predictions.

However, the latter condition is not always met since the human operators may not stick strictly to the procedures, taking into account hidden factors which are difficult to evaluate from the outside.

Even if the decisional autonomy of a human operator therefore makes him/her relatively unpredictable, in any case in tricky or unexpected situations, it is possible to increase the effectiveness of a prediction system by trying to evaluate the intrinsic factors which may intervene in his/her decision-making process.

These intrinsic factors may in particular be the human factors (FH), already mentioned, and for which some existing models allow, for example, the instructors to facilitate the evaluation of their student pilots.

Nevertheless, it is of course not possible to evaluate all the intrinsic factors that will cause the operator to deviate from the procedures, but just those which have a connection with his/her profession of operator. Thus, for a pilot, it will be possible to evaluate his/her alertness, his/her awareness of the situation, his/her stress or his/her mental load for example. However, other undetectable factors could intervene to cause the pilot to make other choices of behavior.

This complex problem has led the inventors to want to “enhance” the procedural models with additional parameters coming from the evaluation of the cognitive state of the operator.

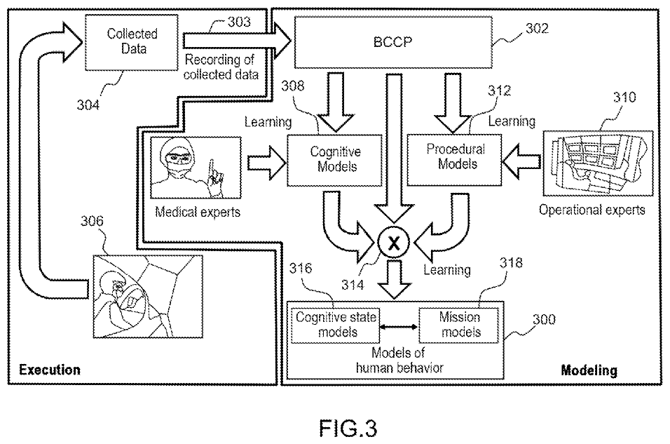

FIG. 3 illustrates schematically and succinctly the process of construction of a model of human behavior (300) according to the invention, in the example of a pilot.

The first step consists in constructing a knowledge base of pilot behavior BCCP (302) (or, more generally, a knowledge base of operator behavior BCCO for an application in question). As previously described, the base is constructed with data collected (304) during the execution of numerous exercises involving various pilots (or operators for the application in question), interacting with a complex system (306) (here, pilots in their aircraft). The collected data characterize actions of observation, of manipulation and of communication of the operator, physiological data relating to the operator and contextual data grouping data on the state and the dynamics of the complex system, environmental data, and data relating to the context of the mission, and potentially, subjective data on the behavior of the operator. These collected data could be used at a later stage by the predictive engine.

In the modeling phase, the Knowledge Base of Pilot Behavior (302) is used to construct a database of cognitive models (308) with the aid of medical experts and using automatic learning algorithms.

In parallel, during the modeling phase of the BCCP, modelers (310) aided by operational experts (here, experienced pilots) define and construct the structure of the procedural models (312) which are subsequently adapted by learning techniques using the data from the BCCP (302), so as to constitute databases of procedural models which are specific to each operator or each category of operators.

Still in the modeling phase, the data collected from exercises which are synchronized (304) and recorded in the Knowledge Base of Pilot Behavior will allow, in combination with the cognitive models and the procedural models, a learning (314) to be implemented in order to construct:
cognitive state models (316) allowing the trend over time of the parameters of human factors of influence to be modeled as a function of the context represented by the operator and the task that he/she is performing using the complex system (for example, the pilot undertaking his/her mission); and
mission models (318) integrating into their rules of operation parameters of human factors of influence, coming from the cognitive state models (316), the human factors being taken into account according to three levels of influence (the three types of connections FH1, FH2, FH3, described in the previous section).

The combination of the two categories of models, the cognitive state models and the mission models, taking into account the parameters of human factors of influence, constitutes the models of human behavior (300) (for a pilot or, more generally, an operator).

The data recorded in the BCCO are therefore used to characterize the choices of behavior of the operators by constructing different models of human behavior for each individual operator (or for categories of operators that are similar in their behavior).

The model of human behavior, which is learnt and instantiated for one operator, is used, in exploitation mode, to initialize an engine for predicting behavior which, using input data characterizing the current situation of the operator, is capable of producing at the output the probability of each of the actions that the operator could carry out in the near future.

It turns out that the technical difficulties and bottlenecks of the approach provided relate to:
The constitution of a knowledge base of operator behavior (302) BCCO for the application in question (BCCP for the pilots) that is sufficiently rich to implement all of the learning processes;
The constitution of a database of cognitive state models (316) whose parameters are sufficient to describe the influences of the state of an operator (for example a pilot) on his/her choices of behavior;
The possibility of learning the models of the trend over time of the various parameters characterizing the cognitive state of the operator (for example of the pilot) as a function of his/her personal characteristics, of his/her perceptions and of his/her actions;
The possibility of learning, based on data from the BCCO (for example from the BCCP), relevant procedural models (312) differentiated according to the operators (e.g.: the pilots) or categories of operators (e.g.: categories of pilots);
The capacity to connect by an automatic learning the data coming from the cognitive state models and from the procedural models in order to reproduce the behaviors of the operators (e.g.: of the pilots) recorded in the BCCO (e.g.: the BCCP).

The latter point is the most difficult to process since, if it may be assumed that the choices of behavior of an operator interacting with a complex system (for example a pilot in his/her aircraft) depend both on his/her perception of his/her environment and on his/her cognitive state, it is more difficult to ensure that all the perceptions relevant to the operator will be taken into account in the model and, moreover, that the measurements captured on the operator will be sufficient for constructing the appropriate models.

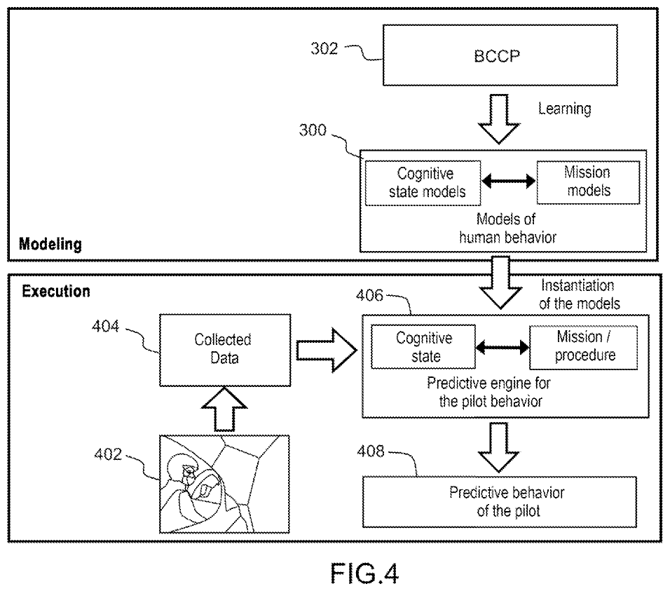

FIG. 4 illustrates schematically an environment allowing the prediction method of the invention to be implemented. The example is illustrated for an aeronautical environment with a view to applying the prediction method to a pilot. However, those skilled in the art may apply the principles described to any other environment as previously mentioned, such as industry and rail or road transport, the fields of safety and security, the fields of the control of processes, etc. and for any operator.

A pilot operates within an environment during a simulation training or during a real mission, illustrated by a platform (402). The platform (cockpit of an aircraft) is a complex system equipped with many and various systems with which the pilot can interact. Amongst others, the cockpits of aircraft are equipped with complex display systems, allowing several display areas to be simultaneously shown on screens. These systems are capable of displaying the information needed for the management of the aircraft and offer various functions for the monitoring of the mission underway, such as the functions of the FMS (Flight Management System), of the FWS (Flight Warning System), functions for assisting the resolution of faults with the display of resolution procedures and their processing. The interaction of the pilot with the complex system is then defined as any action on these systems or any interaction with human-machine interfaces (HMI) of his/her environment.

The pilot is equipped with sensors and the platform already equipped with means of collecting standard data (such as the manipulandum) may also be instrumented, in order to collect data characterizing the interaction of the pilot with the complex system for a situation underway (simulation or real mission). The data are synchronized and grouped in a situational data module (404) which records data relating to the actions of the pilot, physiological data relating to the pilot, contextual data relating to the state and the dynamics of the complex system, relating to the environment and relating to the context of the mission.

The data relating to the actions of the pilot and the physiological data are acquired by means of sensors capable of collecting, for example and without limitation: i) the pulse rate by means of a heart rate monitor bracelet or chest strap; ii) the respiration rate by virtue of the same chest strap or by virtue of an array of sensors situated in or on the seat; iii) the eye-tracking data acquired by means of a camera situated either at a distance from the pilot on the instrument panel or on glasses worn by the pilot; iv) the skin resistance by means of the wrist heart rate monitor or of a dedicated bracelet; v) data on the velocity and the acceleration of the rudder pedals, of the joystick and of the throttle levers by motion sensors worn by the operator on his/her head, on his/her body, on his/her upper and lower limbs or disposed on his/her manipulanda; vi) data relating to the verbal communications of the operator.

With regard to these physiological data or relating to the actions of the pilot, preferably, usual objects already present in the cockpit or on the clothes of the pilot may be equipped with sensors in order not to add interfering elements and thus to reduce the discomfort or distraction of the pilot in his/her interaction with the complex system. Thus, sensors may be implemented on:
a bracelet in contact with the wrist and the arm of the pilot. The bracelet may be equipped with sensors for pulse rate, humidity (perspiration), temperature, accelerometer and inertial (IMU) sensors;
an item of clothing in contact with the skin of the pilot. The clothing may carry, integrated into the material, sensors for temperature of the body, for electrocardiogram ECG and heart rate, and for acceleration (IMU);
a seat in contact with the buttocks and the back of the pilot. The seat may be equipped with pressure, temperature, heart and respiration sensors;
a headset (audio) in contact with the skull of the pilot. In addition to the microphone which is a voice sensor, the headset may support EEG (or even EOG), accelerometer and IMU sensors, and a facial camera.

Preferably, the complex system is instrumented with remote sensors placed close to the pilot. The remote sensors comprise various cameras (wide-field cameras, facial cameras, 3D cameras, gaze-tracking cameras) fixed in the cockpit (i.e. integrated into the instrument panel and/or the risers). These cameras are capable of capturing a scene (the attitude of the pilot, the actions carried out, etc.), of deducing from this postures, facial expressions, and any useful information for composing data which will supply the engine for predicting the behavior of the pilot.

The data relating to the environment may comprise information, obtained from various sources, on the weather conditions, on the state of the air traffic, the data relating to the context of the mission underway (real or simulated).

The data on the context of the mission may comprise information on the state of the complex system (i.e. information on states inherent to a normal operation, such as for example a percentage of power of the engines, if the flaps are retracted or deployed, the state of the fuel tanks, etc., and information on states inherent to an abnormal operation, such as for example the information that the left-hand engine is defective, the right-hand pedal of the copilot's seat is defective, or any kind of potential failure). The contextual data may comprise flight data such as: the itinerary, the altitude, the velocity, the acceleration, the pitch and the envelope. In addition, the parameters of the aircraft may be taken into account, such as: the date of the last maintenance, the in-flight events that occurred, etc.

The device of the invention comprises computing resources or a data processing module (406) configured to implement an engine for predicting the behavior of the pilot with the situational data acquired.

The models of human behavior (300) of the modeling module which have been obtained by learning (such as described with reference to FIG. 3) are instantiated in the engine for predicting the behavior (406) using the acquired situational data which are specific to the pilot being observed, and thus produce prediction data (408) with regard to the actions and to the possible behaviors in the short term that the pilot could carry out or adopt.

The engine for predicting behavior of the invention produces a set of predictive data on actions and on possible behaviors of the pilot at several levels of granularity: from “top level” behaviors linked to the mission and to the procedures down to elementary actions of the operator.

The computing resources may be configured for analyzing and evaluating the prediction data obtained with a view to determining whether technical adaptations or technical adjustments should be applied to equipment of the environment, whether recommendations should be made to the pilot or to third-parties depending on the results of the predictive analysis, in such a manner as to adapt the current interaction of the operator with the system.

The recommendations for a pilot, for example, may be made by way of graphical display on one or more screens or by projection of information into the cockpit.

The device of the invention may, in addition, comprise means which may be a part of the data processing module (406) for analyzing the probabilistic behavior prediction data in order to anticipate the possible variations over time (still as a probability) of the cognitive state of the operator.

Advantageously, the device of the invention is configured so as to feedback onto the modeling module (arrow 303 in FIG. 3 between the execution module and the knowledge base of behavior BCCO or BCCP). The recorded situational data, associated with the behavior of the pilot, are supplied to the BCCO so as to be used as teaching data and to improve the modeling module in order to refine the models of human behavior for this pilot in particular, but also for refining the models of the various categories of pilots to which he/she may belong.

Advantageously, the feedback loop (303) toward the knowledge database of the operator data acquired during the execution of a mission allows the BCCO to be enhanced and the prediction of the behavior of each operator during his/her interaction with the complex system to ultimately be improved.

The execution-modeling feedback also allows knowledge bases of the behavior of several categories of operators to be constituted and enhanced, these bases subsequently being usable for the teaching of various models for predicting the behavior of other operators but also usable as a standard for evaluating a behavior for example.

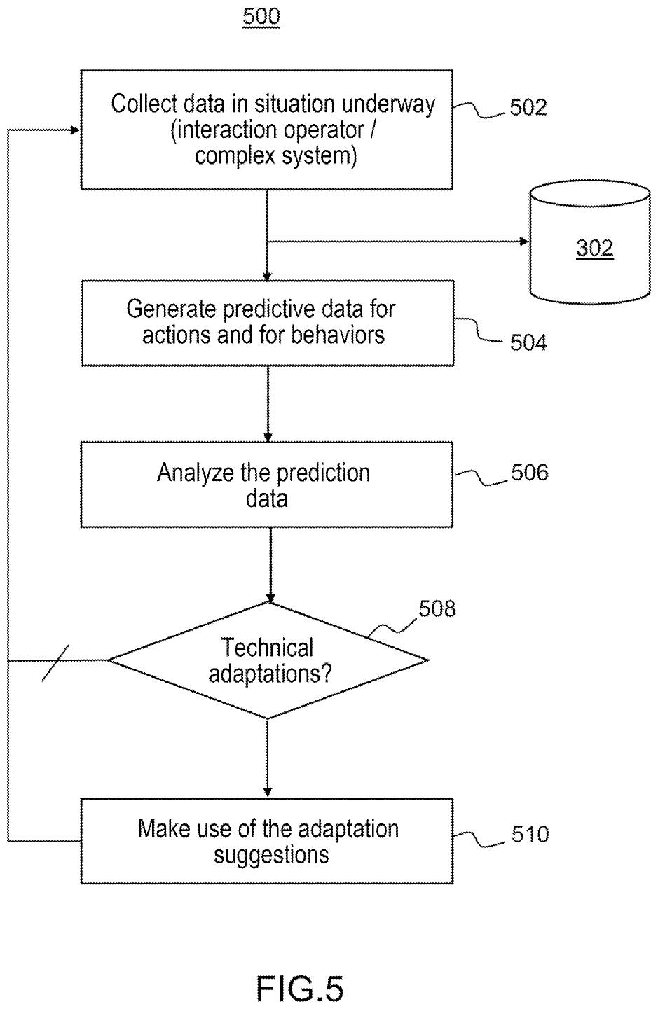

FIG. 5 illustrates a sequence of steps of the method of the invention for the predictive analysis of the behavior of an operator interacting with a complex system during a real or simulated mission. The method is implemented by computer and comprises steps of:
(502): collecting data corresponding to the actions of the operator, physiological data relating to this operator and contextual data characterizing the current situation grouping data relating to the state and to the dynamics of the complex system, data relating to the environment and data relating to the context of the mission;
(504): using the collected data as inputs of an engine for predicting behavior in order to generate prediction data representing actions and behaviors that said operator could carry out in the short term; and
(506) analyzing the prediction data to determine (508) whether technical adaptations are to be applied to the interaction of the operator with the complex system.

The method of the invention is characterized in that the step for generating predictive data is effected by an engine for predicting behavior which implements, with the collected data, a model of human behavior which is configured for modeling the behavior of the observed operator, both in the cognitive and the procedural aspects, this model of human behavior being instantiated for this operator and having been learnt in a learning phase such as previously described, by the application of artificial intelligence techniques to cognitive models and to procedural models, with data being capitalized in a knowledge base of the behavior of operators of complex systems.

The analysis of the prediction data which lists actions and behaviors that the operator could carry out in the short term can allow it to be determined whether one or more actions, whether one or more predicted behaviors, are likely to lead to a problematic situation. This analysis may be made automatically or with the aid of experts and has the aim of determining whether technical adaptations are to be applied to the mode of interaction of the operator with the complex system in all the components of his/her interaction.

Thus, the method of the invention may be completed by a step (510) for using the results of the analysis in order to determine adaptation options as a function of possible risks for the mission, linked to predicted actions and behaviors of the operator. The adaptations may be, without limitation:
to generate warnings (written; visual; audible) intended for the operator and/or for co-operators and/or for control services; and/or
to generate assistance suggestions (written; visual; audible) intended for the operator and/or for third-parties; and/or
to adapt/reconfigure HMIs used by the operator in order to facilitate his/her actions; and/or
to adapt/modify an operation within the complex system in order for a predicted action not to be realized or to be carried out differently (counter-measures may be implemented to mitigate the risks detected and ensure the safety and/or the performance of the mission).

The adaptation examples are only given by way of example and those skilled in the art will be able to derive other options for adapting the human-system interaction according to the context of the application.

The step for implementing the model of human behavior may comprise steps of:
determining, using a sub-set of the collected data, one or more cognitive states of the operator;
characterizing, using a sub-set of the collected data, the perception of the situation by said operator for the operational phase of the mission underway;
using the data on cognitive states as parameters of human factors of influence for the determination of behaviors and of actions of the operator as a function of his/her perception of the situation;
   the model of human behavior being represented as an hierarchical graph comprising modules for cognitive behaviors and modules for tasks relating to a mission, the cognitive behavior modules and the task modules being decomposed into behavior modules, the behavior modules being decomposed into action modules, the actions being elementary actions observable on the operator, the graph comprising an output level corresponding to a selection of elementary actions.

Advantageously, the parameters of human factors of influence on the determination of behaviors and of actions of the operator are used at several levels of the hierarchical graph.

In one embodiment, the parameters of human factors of influence are used at a first level of the graph for determining cognitive behaviors, at a second level of the graph for determining behaviors and actions, and at a third level of the graph for determining the selection of the actions effectively predicted.

In one embodiment, the data collected are supplied to the input of the model of human behavior as teaching data, allowing the model to be updated.

As detailed with reference to FIG. 3, the models of human behavior (300) of the invention are the result of the interconnection and of the mutual influence of cognitive models (308) and of procedural models (312) of the behavior. These models of human behavior will, in particular, allow the behavior of an operator interacting with a complex system to be predicted and to be anticipated.

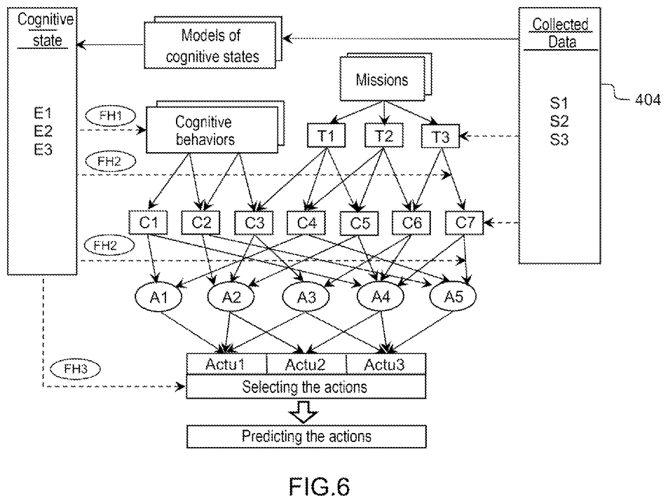

FIG. 6 illustrates one example of implementation of the underlying structure of the model of human behavior of the invention which allows, via the prediction engine, the model of behavior of an operator being observed to be instantiated, this model of behavior for this operator having been obtained from models of human behavior constructed by learning using a knowledge base of operator behavior (BCCO).

For reasons of clarity of the description, the convention adopted in FIG. 6 is that the left-hand side of the tree structure represents the structure associated with the cognitive models, and the right-hand side of the tree structure represents the structure associated with the procedural models of behavior.

The model of human behavior (300) allows an evaluation of the cognitive state of an operator to be carried out, by integrating this state into the evaluation of the situation perceived by the operator for the mission underway.

The cognitive state of an operator is evaluated using various components Ei which represent as many psycho-physiological models allowing which cognitive state the observed operator is in to be evaluated based on the physiological data coming from the sensors. Thus, for example, the components E1, E2 and E3 in FIG. 6 may represent, for a pilot, an evaluation of his/her stress (E1) using a cognitive model for evaluation of stress, an evaluation of his/her alertness (E2) using a cognitive model for evaluation of alertness, an evaluation of his/her mental load (E3) using a cognitive model for evaluation of mental load.

A cognitive behavior CCi of the operator may be triggered by a certain configuration of his/her cognitive state. This behavior corresponds to an influence of first level of the human factors (represented by the arrow FH1), i.e. a level where the human factors may trigger a new behavior. Thus, for example, the evaluation of the cognitive state of a pilot showing a very low level of his/her alertness may lead to a cognitive behavior which is the pilot falling asleep.

However, a cognitive behavior is not necessarily elementary, and it may be decomposed into a plurality of simpler behaviors Ci (for example the behavior modules C1 to C4).

The behaviors Ci may themselves each be decomposed into a plurality of observable elementary actions Ai of the operator (for example the modules of actions A1 to A5).

The whole of this hierarchical structure (Ci; Ai) of the model of the cognitive behavior may be the result of an automatic learning, combined with an expertise on the cognitive models.

As regards the procedural aspect, the evaluation of the situation for a mission underway, which is that perceived by an operator or that of the operator, groups a set of collected data Sj which are recorded using sensors allowing what the observed observer sees, hears or knows, and what he/she is feeling, to be evaluated.

The operator has one or more missions which are assumed to be known. Each of these missions may be decomposed in a hierarchical manner into a plurality of procedural tasks Tj (for example the modules of tasks T1, T2, T3), which, themselves, are each decomposable into behaviors (for example the modules of behaviors C3 to C7).

The behaviors Cj may themselves each be decomposed into a plurality of observable elementary actions Aj of the operator (for example the modules of actions A1 to A5) that he/she may carry out in order to undertake his/her mission.

In the same way as for the cognitive behaviors, the hierarchical structure (Tj; Cj; Aj) of the procedural behaviors may be the result of an automatic learning, combined with doctrinal knowledge of an operational expert.

Advantageously, the model of human behavior of the invention establishes links between the cognitive models and the procedural models of behavior, according to the hierarchical structure of the behavioral tree and of the missions tree. These links (illustrated in FIG. 6 by all the interconnections between the various hierarchical levels of two categories of models) allow a representation of the behavior of an operator in all its components (cognitive and procedural) to be obtained.

A first level of interconnection is the possibility of having modules of behavior (Ci, Cj) that are common in the tree structure, where these behavior modules may be activated either by a cognitive behavior or by a task of a mission or by both simultaneously.

FIG. 6 illustrates that the behavior module C3 is a common behavior module. The behavior module C3 comes from a cognitive behavior CCi and it also comes from the decomposition of the task referenced in the task module T1. Thus, during the implementation of the model of human behavior, behavior modules which are common to the two models may be activated either by a cognitive behavior or by a task of a mission or by both simultaneously (and then provide a compromise behavior).

A second level of interconnection corresponds to the second level of influence of the human factors (FH2), i.e. the level where the human factors can influence the choice between several ways of achieving a given behavior. The principle consists in using the cognitive state of the operator in order to influence the decomposition of the tasks Tj or the decomposition of the behaviors (Ci, Cj) of the mission tree. For example, a very low state of alertness revealed by the evaluation of the cognitive state of the operator may increase the weight in the behavioral tree of a more cautious behavior.

A third level of interconnection is located at the level of the triggering of the actions. Indeed, the two behavioral hierarchies (cognitive; procedural) are necessarily in competition at this level. Each action module (Ai, Aj) may be activated by a module of the cognitive tree, by a module of the mission tree or by both at the same time.

FIG. 6 illustrates for example that the action module A1 is common to the behavior module C1 coming from the decomposition of a cognitive behavior and to the behavior module C4 coming from the decomposition of the task module (T1 and/or T2).

The last level of the tree structure is that of the selection of the predicted actions (illustrated at the bottom of FIG. 6). This level operates according to the known principle of actuators. Each predicted action is represented by a combination of one or of several actuators (Actu1, Actu2 and Actu3). This determines the possibility of excluding simultaneous actions but also of carrying out several actions simultaneously. The example for a military pilot is that he/she cannot look at his/her instruments and at the outside of his/her cockpit at the same time. On the other hand, he/she may very easily carry out one of these two actions and, at the same time, squeeze the trigger of his/her gun.

At the end of the process of selection of the actions, the model of human behavior of the invention brings into play, on this last level of the tree structure, the last level (FH3) of influence of the human factors on the behavior (illustrated by the arrow FH3 in FIG. 6), i.e. the level where the human factors may have an influence on the efficiency with which actions will be carried out.

Indeed, the cognitive state of the operator may alter the efficiency of the actuators, thus limiting the performance of the selected actions. The cognitive state is then taken into account for the selection of the actions. For example, a shaking of the hands due to stress or the tunnel vision phenomenon which limits the field of view may be modeled and taken into account in the selection of the actions made by the model.

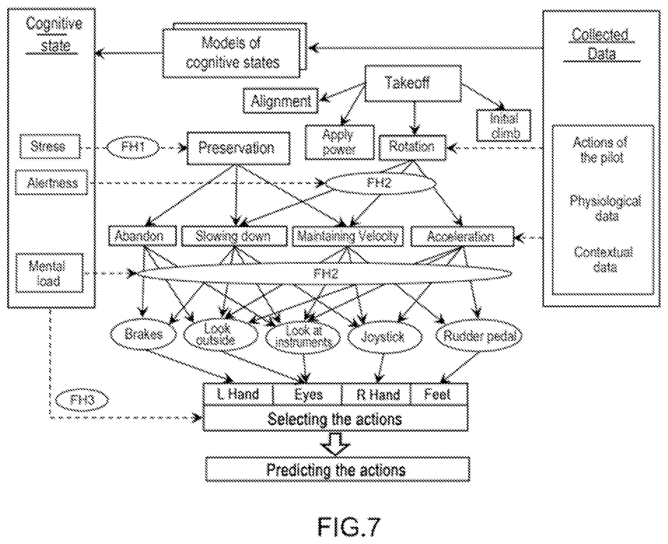

FIG. 7 illustrates one example of prediction of the actions of an aircraft pilot, based on the hierarchical structure in FIG. 6.

In this example, purposely simplified with respect to the true models of human behavior, the assumption is made that the pilot is instrumented with sensors, and that cognitive models learnt in a prior phase allow the stress, the alertness and the mental load of the observed pilot to be evaluated, during the takeoff phase of his/her aircraft.

The predictive engine allows the handling of the procedures carried out by the pilot to be followed during the various steps of this phase of flight going from the alignment on the runway up to the initial climb.

In this exercise scenario, at the moment of the rotation phase, which is the phase allowing the acceleration of the aircraft down the runway until the takeoff velocity is reached, an incident is introduced consisting of a flock of birds crossing the runway, where this incident may be a source of danger for the aircraft and its occupants.

The construction of the model of human behavior allows the behavior of the pilot in this situation to be modeled then predicted.

The cognitive state of stress of the pilot has an influence on his/her cognitive behavior (human factor of influence FH1). Thus, a rise in the stress of the pilot may activate a “Preservation” behavior.

A preservation behavior with an increased level of stress may have as a consequential behavior the abandoning of the takeoff.

The alertness of the pilot can influence his/her procedural behaviors for the mission underway (human factor of influence FH2). Thus, the evaluation of an absence of alertness of the pilot may influence his/her procedural behavior, and lead to him/her continuing with the “Acceleration” as if nothing had happened.

On the other hand, an increased alertness or a more controlled stress level may lead to the pilot adopting two other behaviors: either a “Slowing down” or a “Maintaining Velocity” in order to allow the pilot to let the flock of birds fly past before continuing with the takeoff procedure.

Irrespective of the behavior predicted by the engine as a function of the perceived situation and of the state of the pilot, this predicted behavior is decomposed into several elementary actions, which may potentially be simultaneous. These elementary actions may also be altered by a high level of the mental load of the pilot (human factor of influence FH2).

In the example where the takeoff is abandoned, the elementary actions of the pilot may for example be: a braking action, an action for external monitoring, an action for monitoring the instruments.

The effective implementation of the actions selected by the pilot goes via the use of actuators (hands, feet, eyes) whose efficiency may also be diminished by an abnormal level of the state of the pilot (human factor of influence FH3).

Irrespective of the situation of the airplane and the cognitive state of the pilot, the model of human behavior learnt must allow the predictive engine not only to predict the actions that will effectively be carried out by the pilot, but also to supply a level of quality of this prediction in the form of a probability value.

The present description illustrates one preferred embodiment of the invention, which is non-limiting. Examples are chosen to allow a clear understanding of the principles of the invention and one concrete application, in particular in the field of avionics, but they are not exhaustive and must allow those skilled in the art to apply modifications and variants of implementation depending on the fields of application, while conserving the same principles.

The device and the method of the invention are advantageous for all the systems involving an interaction between an operator and a complex system, in the sense that they allow a better prediction of the behavior of the operator in the execution of his/her tasks (by the human factors analysis).

Many industrial applications will gain advantages with the implementation of the device and the method of the invention, notably in a non-exhaustive manner:
the field of transport (aeronautics, rail, maritime, automobile, etc.);
the field of situational management (air traffic control, public safety and security, etc.);
the field of the management of processes (energy production, etc.).

The exploitation of the invention may relate to:
the monitoring of the execution, by an operator, of a mission or of a process implementing a complex system;
the education and training of operators for the operation of their system.

In summary, the main elements of the present invention relate to:
a method for creating a database of models of human behavior of operators interacting with a complex system, integrating both cognitive elements (state of the operator), procedural elements (missions and procedures of the operator) and the various interactions between these two categories of elements. This database is constituted by virtue of an automatic learning using data recorded in a knowledge base of operator behavior during interaction sessions of a cohort of operators with the complex system being studied;
a device (and its method) allowing the behavior of an operator interacting with a complex system to be predicted, and the trend over time of his/her cognitive state, based on current data from the interaction session of the operator with this complex system. The device relies on the database of models of human behavior of the operators which has been constituted in order to produce models of behavior which benefit both from the cognitive aspects and from the procedural aspects that may be observed on a real person.

Beyond these points, the present invention constitutes a novel way of grasping the modeling of the behavior of an operator or of a class of operators by an automatic learning which is capable of making use of both expert data, characterizing the behavior of this operator or of this class of operators in a procedural manner, and real data coming from the recording of the behavior of this operator or of this class of operators when interacting with the complex system being studied.

1. A method for predictive analysis of the behavior of an operator interacting with a complex system during a real or simulated mission, the method being implemented by computer and comprising steps of:
collecting data characterizing actions of observation, of manipulation and of communication of the operator, physiological data relating to the operator and contextual data combining data on the state and the dynamics of the complex system, environmental data, and data relating to the context of the mission;
using the collected data as inputs of an engine for predicting behavior in order to generate prediction data representing actions and behaviors that said operator could carry out in the short term; and
analyzing the prediction data in order to determine whether technical adaptations are to be applied to the interaction between the operator and the complex system;
wherein the step for generating prediction data comprises, via said engine for predicting behavior, in implementing, with the collected data, a model of human behavior configured for modeling the behavior of said operator being observed with regard to the cognitive and procedural aspects, said model of human behavior instantiated for said observed operator having been learnt, in a learning phase, by the application of artificial intelligence techniques to cognitive models and to procedural models, using, over many simulations, a plurality of teaching data of the same nature as said collected data, but for various operators, the teaching data being capitalized in a knowledge base of the behavior of operators of complex systems.

2. The method as claimed in claim 1, wherein the step for implementing the model of human behavior for said operator comprises steps of:
determining, from a sub-set of the collected data, one or more cognitive states of the operator;
characterizing, from a sub-set of the collected data, the perception of the situation by said operator, for the operational phase during the mission;
using the data on cognitive states as parameters of human factors of influence for the determination of behaviors and of actions of the operator, as a function of his/her perception of the situation;
the model of human behavior being represented as a hierarchical graph comprising modules of cognitive behaviors and modules of tasks relating to a mission, the modules of cognitive behaviors and the modules of tasks being decomposed into modules of behaviors, the modules of behavior being decomposed into modules of actions, the actions being elementary actions observable on the operator, the graph comprising an output level corresponding to a selection of elementary actions.

3. The method as claimed in claim 2, wherein the parameters of human factors of influence on the determination of behaviors and of actions of the operator are used at several levels of the hierarchical graph.

4. The method as claimed in claim 3, wherein the parameters of human factors of influence are used at a first level of the graph to determine cognitive behaviors, at a second level of the graph to determine behaviors and actions, and at a third level of the graph to determine a selection of actions.

5. The method as claimed in claim 1, wherein the step for analyzing the prediction data in order to determine whether technical adaptations are to be applied to the interaction between the operator and the complex system comprises identifying possible risks for the mission, linked to predicted actions and behaviors of the operator.

6. The method as claimed in claim 1, further comprising determining adaptation suggestions as regards the interaction between said observed operator and the complex system.

7. The method as claimed in claim 6, further comprising steps of:
generating written and/or visual and/or audible warnings, intended for said observed operator and/or for co-operators and/or for control services; and/or
generating written and/or visual and/or audible assistance suggestions, intended for said observed operator and/or for third-parties; and/or
adapting/reconfiguring HMIs used by said observed operator in order to facilitate his/her actions; and/or
adapting/modifying an operation within the complex system in order for a predicted action not to be realized or to be carried out differently.

8. The method as claimed in claim 1, further comprising supplying the collected data to the input of the model of human behavior as teaching data.

9. The method as claimed in claim 1, comprising initial steps of an automatic learning of models of human behavior.

10. The method as claimed in claim 9, wherein the step for automatic learning of the models of human behavior comprises steps of:
constructing a knowledge base of operator behavior BCCO using data coming from operators interacting with the complex system;
using the data from the BCCO to construct by learning a database of cognitive models;
using the data from the BCCO to construct by learning a database of models specific to each operator or to each category of operators;
using the data from the BCCO, the data from the database of cognitive models, the data from the database of specific models to construct by learning:
cognitive state models allowing the trend over time of the human factors parameters to be modeled as a function of the context represented by the operator and the task that he/she is performing using the complex system;
mission models integrating into their rules of operation parameters of human factors of influence coming from the cognitive state models, the parameters being taken into account according to three levels of influence;
the combination of cognitive state models and of mission models constituting models of human behavior for operators or for categories of operators.

11. A device for predictive analysis of the behavior of an operator interacting with a complex system during a real or simulated mission, the device comprising:
a plurality of sensors configured for collecting data characterizing actions of observation, of manipulation and of communication of the operator, physiological data relating to the operator and contextual data combining data on the state and the dynamics of the complex system, environmental data, and data relating to the context of the mission;
a data processing module coupled to the various sensors, and comprising code instructions allowing steps to be carried out comprising:
using the collected data as inputs of an engine for predicting behavior in order to generate prediction data representing actions and behaviors that said operator could carry out in the short term; and
analyzing the prediction data in order to determine whether technical adaptations are to be applied to the interaction between the operator and the complex system;
wherein the engine for predicting behavior implements, with the data collected, a model of human behavior configured for modeling the behavior of said observed operator with regard to the cognitive and procedural aspects, said model of human behavior instantiated for said observed operator having been learnt, in a learning phase, by the application of artificial intelligence techniques to cognitive models and to procedural models, using, over many simulations, a plurality of teaching data of the same nature as said collected data, but for various operators, the teaching data being capitalized in a knowledge base of the behavior of operators of complex systems.

12. A device for predictive analysis of the behavior of an operator interacting with a complex system during a real or simulated mission, the device comprising:
a plurality of sensors configured for collecting data characterizing actions of observation, of manipulation and of communication of the operator, physiological data relating to the operator and contextual data combining data on the state and the dynamics of the complex system, environmental data, and data relating to the context of the mission;
a data processing module coupled to the various sensors, and comprising code instructions allowing steps to be carried out comprising:
using the collected data as inputs of an engine for predicting behavior in order to generate prediction data representing actions and behaviors that said operator could carry out in the short term; and
analyzing the prediction data in order to determine whether technical adaptations are to be applied to the interaction between the operator and the complex system;
wherein the engine for predicting behavior implements, with the data collected, a model of human behavior configured for modeling the behavior of said observed operator with regard to the cognitive and procedural aspects, said model of human behavior instantiated for said observed operator having been learnt, in a learning phase, by the application of artificial intelligence techniques to cognitive models and to procedural models, using, over many simulations, a plurality of teaching data of the same nature as said collected data, but for various operators, the teaching data being capitalized in a knowledge base of the behavior of operators of complex systems;
further comprising means for implementing the steps of the method as claimed in claim 2.

13. A use of the device as claimed in claim 11, for the predictive analysis of the behavior of an operator interacting with an aircraft platform during a real or simulated mission.

14. A computer program comprising code instructions for the execution of the steps of the method as claimed in claim 1, when said program is executed by a processor.

15. A method for constructing models of human behavior, comprising steps of:
constructing a knowledge base of operator behavior BCCO using data coming from operators interacting with the complex system;
using the data from the BCCO to construct by learning a database of cognitive models;
using the data from the BCCO to construct by learning a database of models specific to each operator or to each category of operators;
using the data from the BCCO, the data from the database of cognitive models, the data from the database of specific models to construct by learning:
cognitive state models allowing the trend over time of parameters of human factors of influence to be modeled, as a function of the context represented by the operator and the task that he/she is performing in his/her interaction with the complex system;
mission models integrating into their rules of operation the parameters of human factors of influence coming from the cognitive state models, the parameters being taken into account according to three levels of influence;
the combination of cognitive state models and of mission models constituting models of human behavior for operators or for categories of operators.

16. A device for constructing models of human behavior comprising means for implementing the steps of the method as claimed in claim 15.

17. The device as claimed in claim 16, wherein the means comprise artificial intelligence means to effect automatic learning.
